(19) United States
(12) Patent Application Publication
(10) Pub. No.: US 2026/0056523 A1
(43) Pub. Date: Feb. 26, 2026

(54) METHOD OF CONTROLLING EXHAUSTING OF EQUIPMENT IN MULTI-EQUIPMENT SYSTEM

(71) Applicant: SAMSUNG ELECTRONICS CO, LTD., Suwon-si (KR)

(72) Inventors: Seungman KIM, Suwon-si (KR); Seokryul KIM, Suwon-si (KR); Sunghyup KIM, Suwon-si (KR); Sanghoon LEE, Suwon-si (KR); Hanahchim CHOUNG, Suwon-si (KR); Byoungcheol HWANG, Suwon-si (KR)

(73) Assignee: SAMSUNG ELECTRONICS, LTD., Suwon-si (KR)

(21) Appl. No.: 19/051,648

(22) Filed: Feb. 12, 2025

(30) Foreign Application Priority Data
Aug. 21, 2024 (KR) 10-2024-0112344

(51) Int. Cl. G05B 17/02

(52) U.S. Cl. CPC G05B 17/02

(57) ABSTRACT

A method of controlling exhausting of equipment in a multi-equipment system includes receiving an input of information about a plurality of equipment and a plurality of pipes corresponding to the plurality of equipment, where the plurality of pipes are connected to a central pipe, performing a simulation of activation or deactivation of the plurality of equipment based on the information and based on a pressure of the central pipe, and determining an activation order or a deactivation order for the plurality of equipment based on a result of the simulation.

### CROSS-REFERENCE TO RELATED APPLICATION

This application is based on and claims priority under 35 U.S.C. § 119 to Korean Patent Application No. 10-2024-0112344, filed on Aug. 21, 2024, in the Korean Intellectual Property Office, the disclosure of which is incorporated by reference herein in its entirety.

### BACKGROUND

The present disclosure relates to a method of controlling a multi-equipment system, and in particular, to a method of controlling exhausting of equipment in a multi-equipment system.

Generally, during a process of manufacturing a semiconductor, a display panel, or a solar cell, an etching, deposition, cleaning, or nitriding process may be performed in a process chamber. Gases used in this manufacturing process are converted into process by-products such as unreacted gas or waste gas as they go through the manufacturing process, and are discharged from the process chamber by using a vacuum pump. For example, the vacuum atmosphere created within the process chamber is generated by suction action of the vacuum pump connected to the process chamber via a vacuum pipe, and reaction gas or a process by-product, which is suctioned by the vacuum pump, is discharged to the outside through an exhaust pipe. When exhausting through a pipe is not performed smoothly, damage to the process chamber or the pipe may occur or a defect in the process may occur.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide a method of controlling exhausting of equipment in a multi-equipment system, in which exhaust performance may be improved by optimizing a pressure change within the multi-equipment system.

Additional aspects will be set forth in part in the description which follows and, in part, will be apparent from the description, or may be learned by practice of the presented embodiments.

According to an aspect of an example embodiment, a method of controlling exhausting of equipment in a multi-equipment system may include receiving an input of information about a plurality of equipment and a plurality of pipes corresponding to the plurality of equipment, where the plurality of pipes are connected to a central pipe, performing a simulation of activation or deactivation of the plurality of equipment based on the information and based on a pressure of the central pipe, and determining an activation order or a deactivation order for the plurality of equipment based on a result of the simulation.

According to an aspect of an example embodiment, a method of controlling exhausting of equipment in a multi-equipment system may include receiving an input of information about a plurality of equipment and about a plurality of pipes corresponding to the plurality of equipment, where the plurality of pipes are connected to a central pipe, performing a simulation of activation or deactivation of the plurality of equipment based on the information and based on a pressure of the central pipe, storing a result of the simulation in a database, determining an activation order or a deactivation order for the plurality of equipment based on data stored in the database, and controlling exhausting of the plurality of equipment based on the activation order or the deactivation order.

According to an aspect of an example embodiment, a method of controlling exhausting of a plurality of equipment in a multi-equipment system may include performing a simulation of activation order or deactivation of the plurality of equipment, where the plurality of equipment are connected to a plurality of pipes that are connected to a central pipe, determining an activation order or a deactivation order for the plurality of equipment based on a result of the simulation, and controlling exhausting of the plurality of equipment based on the activation order or the deactivation order, where the simulation is performed based on a pressure in the central pipe.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a flowchart illustrating a method of controlling exhausting of equipment in a multi-equipment system, according to one or more embodiments;

FIG. 2 is a block diagram of an exhaust control system that performs a method of controlling exhausting of equipment according to one or more embodiments;

FIGS. 3A and 3B are respectively three-dimensional (3D) and two-dimensional (2D) configuration diagrams of a pipe system of a multi-equipment system according to one or more embodiments;

FIG. 4 is a flowchart illustrating an operation of predicting activation/deactivation of equipment according to one or more embodiments;

FIGS. 5A and 5B are flowcharts illustrating operations of performing a first simulation and an operation of performing a second simulation, according to one or more embodiments;

FIG. 6 is a flowchart illustrating an operation of determining an activation/deactivation order for equipment according to one or more embodiments;

FIG. 7A is an activation table illustrating a result of a first simulation according to an activation order according to one or more embodiments;

FIG. 7B is a graph illustrating a pressure change according to an activation order for equipment based on maximum values according to one or more embodiments; and

FIG. 8 is a graph illustrating a comparison of changes in pressure between a comparative example and one or more embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

In the disclosure, reference to “activation” may indicate an activating of equipment, and reference to “deactivation”may indicate a deactivating of equipment.

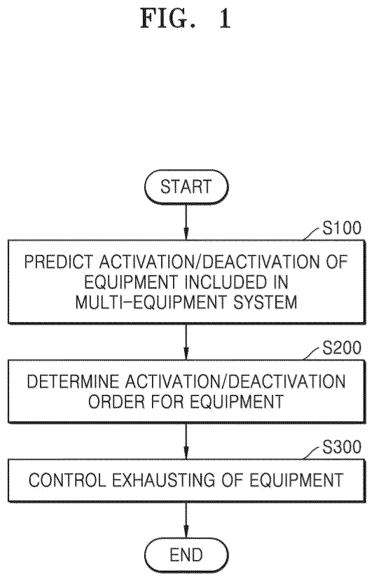

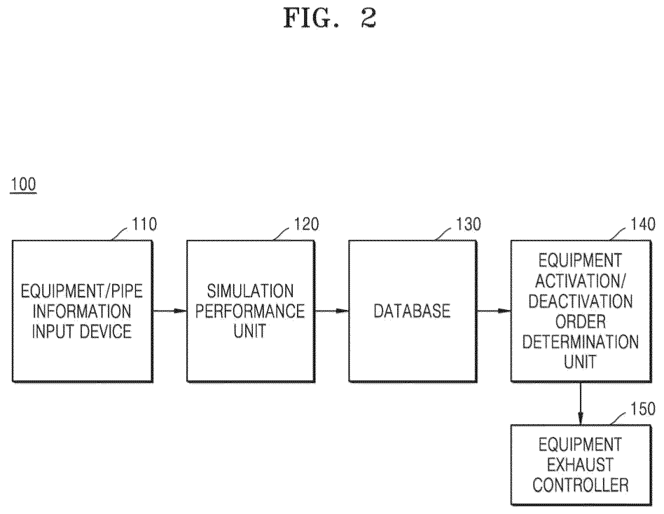

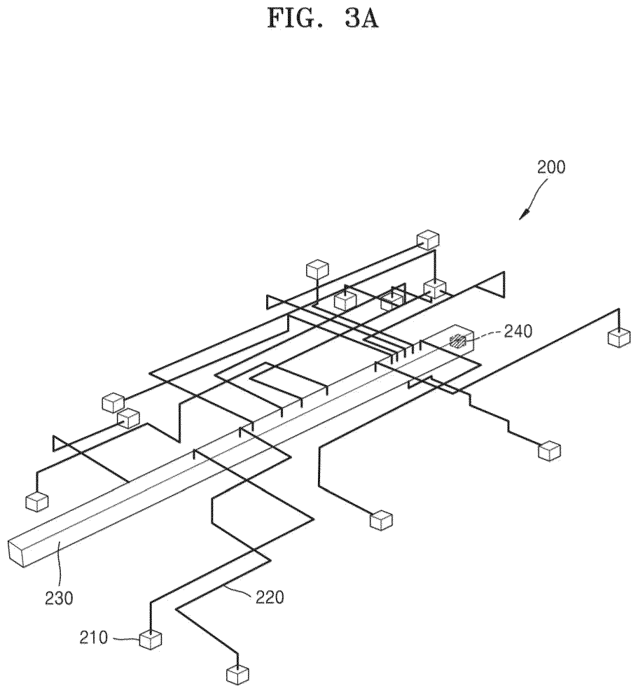

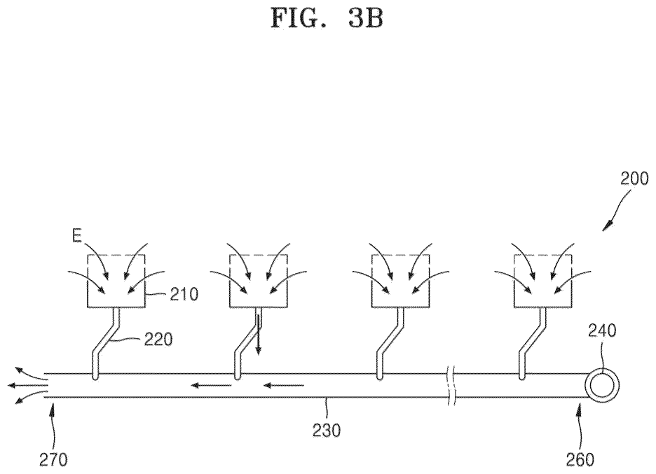

FIG. 1 is a flowchart illustrating a method of controlling exhausting of equipment in a multi-equipment system, according to one or more embodiments. FIG. 2 is a block diagram of an exhaust control system that performs a method of controlling exhausting of equipment according to one or more embodiments. FIGS. 3A and 3B are respectively three-dimensional (3D) and two-dimensional (2D) configuration diagrams of a pipe system of a multi-equipment system according to one or more embodiments.

Referring to FIGS. 1 to 3B, the method of controlling the exhausting of the equipment in the multi-equipment system (hereinafter, simply referred to as “the method of controlling the exhausting of equipment”) may include predicting activation/deactivation of equipment included in a multi-equipment system 200 in operation S100. In this regard, the multi-equipment system 200 may include a plurality of equipment 210, a plurality of pipes 220, and a central pipe 230, as shown in FIGS. 3A and 3B.

The equipment 210 may include process chambers used in a semiconductor manufacturing process (for example, an etching, deposition, cleaning, or nitriding process). However, the equipment 210 is not limited to process chambers. In addition, a process related to the equipment 210 is not limited to the semiconductor manufacturing process. Furthermore, the equipment 210 may be connected to a vacuum pump. An internal pressure of the equipment 210 may be adjusted through the vacuum pump, and exhaust gas may be discharged to the outside from the equipment 210.

The pipes 220 may be arranged between the equipment 210 and the central pipe 230. Exhaust gas generated from the equipment 210 may be discharged to the central pipe 230 through the pipes 220. In addition, the discharging of the exhaust gas through the pipes 220 may significantly depend activation pressure in the central pipe 230. For example, when the pressure in the central pipe 230 is sufficient, that is, when exhaust pressure is high, the exhaust gas may be smoothly discharged. In contrast, when exhaust pressure in the central pipe 230 is not sufficient, that is, when the exhaust pressure is low, the exhaust gas may not be smoothly discharged. When the exhaust gas is not smoothly discharged, a process chamber (e.g., equipment 210), a vacuum pump, and a pipe (e.g., pipes 220) may be damaged by the exhaust gas, and in some cases, a defect in the process may occur. Therefore, it should be ensured that exhaust gas is smoothly discharged through the pipes 220.

The central pipe 230 may have a relatively wide passage as compared to the pipes 220 and extend in one direction, as shown in FIG. 3A or 3B. In other words, each of the pipes 220 may have a relatively narrow passage, whereas the central pipe 230 may have a wide passage that may encompass all of the pipes 220 (e.g., the central pipe 230 may have a width that is equal to or greater than the combined widths of the pipes 220). The central pipe 230 may be referred to as a lateral pipe.

In FIG. 3B, exhaust gas E (represented by arrows), that may be a reaction gas, a process by-product gas, etc., of each of the equipment 210 may flow to the central pipe 230 through a corresponding pipe 220 and be combined in the central pipe 230. In addition, exhaust gas in the central pipe 230 may flow from an inlet 260 to an outlet 270 and may be discharged through the outlet 270.

In addition, as shown in FIGS. 3A and 3B, a pressure sensor 240 may be arranged within the inlet 260 of the central pipe 230. For reference, pressure may be largely divided into static pressure and dynamic pressure. The static pressure may correspond to pressure applied by a fluid when there is no fluid flow, and the dynamic pressure may correspond to pressure caused by fluid flow with density and flow speed of the fluid as variables. In addition, pressure that combines a static pressure component and a dynamic pressure component may be referred to as total pressure. In the method of controlling the exhausting of the equipment, the pressure sensor 240 may be, for example, a static pressure sensor and may be arranged within the inlet 260 of the central pipe 230.

In addition, the activation/deactivation of the equipment 210 may refer to activation/deactivation of the equipment 210 and/or activation/deactivation of the pipes 220. For example, when the equipment 210 are process chambers, activation/deactivation of any one of the equipment 210 may indicate that a corresponding process chamber and a corresponding pipe 220 are activated/deactivated together. In addition, activation/deactivation of any one of the equipment 210 may indicate that after activation/deactivation of a corresponding chamber, a corresponding pipe 220 is activated/deactivated. In addition, the activation/deactivation of the pipe 220 may be achieved through automatic opening/closing control of a valve of the pipe 220.

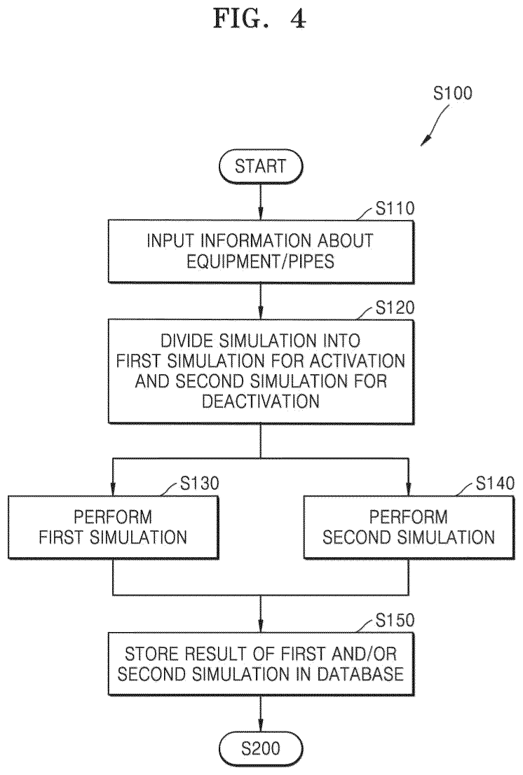

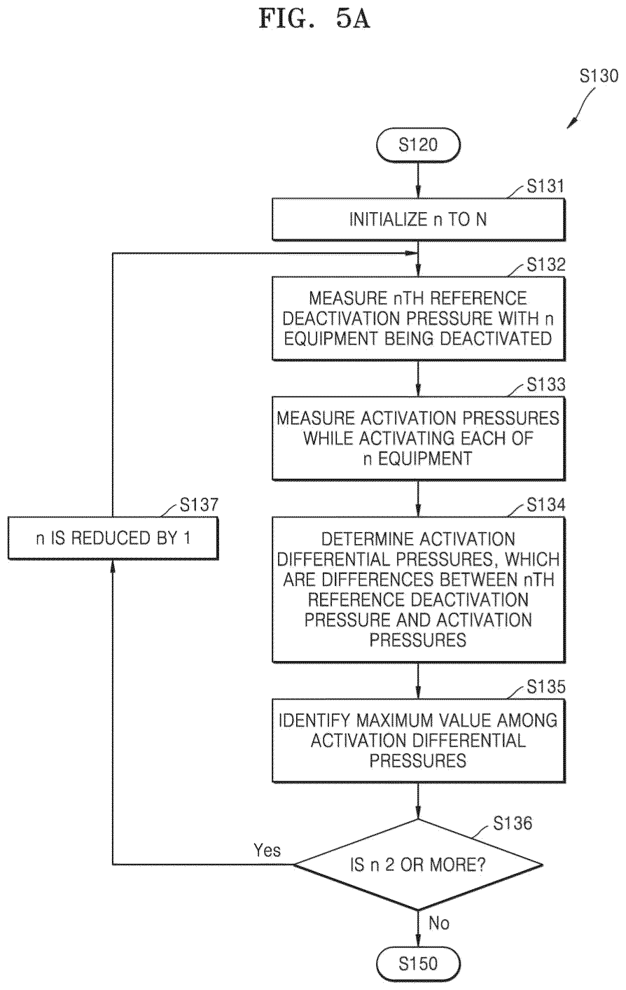

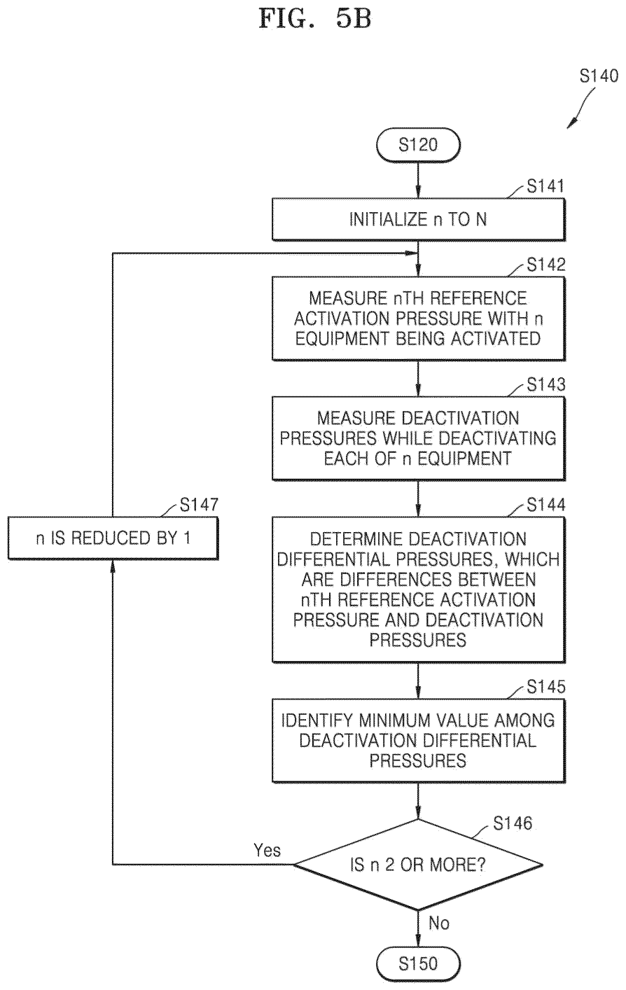

In the method of controlling the exhausting of the equipment according to one or more embodiments, the predicting of the activation/deactivation of the equipment 210 of operation S100 may be achieved through a simulation of the activation/deactivation of the equipment 210. The simulation may be performed based activation pressure in the central pipe 230 according to the activation/deactivation of the equipment 210. In addition, as described above, the pressure may be measured through the pressure sensor 240 arranged within the inlet 260 of the central pipe 230. In addition, the simulation of the activation/deactivation of the equipment 210 may be performed by a simulation performance unit 120 of an exhaust control system 100 of FIG. 2. The predicting of the activation/deactivation of the equipment 210 in operation S100 is described in more detail in the descriptions of FIGS. 4A to 5B.

After predicting the activation/deactivation of the equipment 210, an activation/deactivation order for the equipment 210 may be determined in operation S200. The activation/deactivation order for the equipment 210 may be determined based on a result of the simulation of the predicting of the activation/deactivation of the equipment 210 in operation S100. For example, the activation of the equipment 210 may be determined by arranging maximum values of differential pressures relative to existing pressure in descending order when each of the equipment 210 is activated. In addition, the deactivation of the equipment 210 may be determined by arranging minimum values of differential pressures relative to existing pressure in ascending order when each of the equipment 210 is deactivated. In addition, the determination of the activation/deactivation order for the equipment 210 may be performed by an equipment activation/deactivation order determination unit 140 of the exhaust control system 100 of FIG. 2.

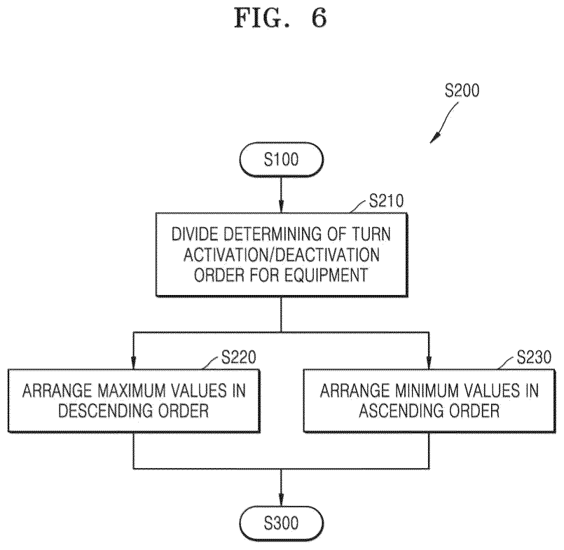

The maximum values when the equipment 210 is activated and the minimum values when the equipment 210 is deactivated are described in more detail in the descriptions of FIGS. 5A and 5B. In addition, the activation order and the deactivation order for the equipment 210 are described in more detail in the description of FIG. 6.

After the determination of the activation/deactivation order for the equipment 210, exhausting of the equipment 210 may be controlled in operation S300. In other words, the activation/deactivation of the equipment 210 may be controlled according to the activation/deactivation order for the equipment 210, which has been previously determined. In this regard, the controlling of the activation/deactivation of the equipment 210 may indicate that activation or deactivation of the process chamber and the pipe 220 in each of the equipment 210 is controlled together. In addition, the controlling of the activation/deactivation of the equipment 210 may indicate that after activation or deactivation of a process chamber in each of the equipment 210, activation or deactivation of a corresponding pipe 220 is controlled. In addition, the controlling of the activation or deactivation of the pipe 220 may be achieved through automatic opening/closing control of a valve of the pipe 220. In addition, the controlling of the exhausting of the equipment 210 may be performed by an equipment exhaust controller 150 of the exhaust control system 100 of FIG. 2. The controlling of the exhausting of the equipment 210 is described in more detail in the description of FIG. 6.

The method of controlling the exhausting of the equipment according to one or more embodiments may be performed by the exhaust control system 100 of FIG. 2. The exhaust control system 100 may include an equipment/pipe information input device 110, the simulation performance unit 120, a database (DB) 130, the equipment activation/deactivation order determination unit 140, and the equipment exhaust controller 150. Information about the equipment 210 and the pipes 220 included in the multi-equipment system 200 may be input into the equipment/pipe information input device 110. For example, information about the equipment 210 may include the type of exhaust gas used in each of the equipment 210 and the maximum exhaust amount of each of the equipment 210. In addition, information about the pipes 220 may include, for example, the shape or exhaust capacity of each of the pipes 220.

The simulation performance unit 120 may determine differential pressure which is a difference between a first pressure measured when activating or deactivating each of at least some of the equipment 210 and a second pressure before activating/deactivating each of the at least some of the equipment 210. In detail, the first pressure and the second pressure may be measured by using the pressure sensor 240 arranged within the inlet 260 of the central pipe 230, and the simulation performance unit 120 may determine differential pressure which is a difference between the measured first pressure and the measured second pressure. In addition, the simulation performance unit 120 may identify maximum values and minimum values among determined differential pressures. A simulation performed by the simulation performance unit 120 is described in more detail in the descriptions of FIGS. 4 to 5B. For reference, the first pressure may correspond to activation pressure or deactivation pressure in FIGS. 4 to 5B, and the second pressure may correspond to an n^{th} reference deactivation pressure or an n^{th} reference activation pressure in FIGS. 4 to 5B. In addition, differential pressure may correspond to the activation differential pressure or the deactivation differential pressure in FIGS. 4 to 5B.

A result of the simulation performed by the simulation performance unit 120 may be stored in the DB 130. For example, maximum values and minimum values determined in the simulation may be stored in the DB 130. In addition, in the DB 130, not only are the maximum values and minimum values stored, but the equipment 210 corresponding to the maximum values and the minimum values may also be linked and stored. In addition, information stored in the DB 130 is not limited to the maximum values and the minimum values. For example, all information necessary to perform the method of controlling the exhausting of the equipment may be stored in the DB 130, in addition to the maximum values and the minimum values. For example, the information about the equipment 210 and the pipes 220 may be pre-stored in the DB 130 and then may be input into or transmitted to the equipment/pipe information input device 110 and/or the simulation performance unit 120.

The equipment activation/deactivation order determination unit 140 may determine the activation/deactivation order for the equipment 210 by using the maximum values and the minimum values stored in the DB 130 and information about the equipment 210 corresponding to these values. For example, in the case of the activation of the equipment 210, the equipment activation/deactivation order determination unit 140 may determine the activation order for the equipment 210 by arranging the maximum values in descending order. In addition, in the case of the deactivation of the equipment 210, the equipment activation/deactivation order determination unit 140 may determine the deactivation order for the equipment 210 by arranging the minimum values in ascending order.

The equipment exhaust controller 150 may control exhausting of the equipment 210 according to the order determined by the equipment activation/deactivation order determination unit 140. For example, in the case of the activation of the equipment 210, the equipment exhaust controller 150 may control the activation of the equipment 210 according to the descending order of the maximum values. In addition, in the case of the deactivation of the equipment 210, the equipment exhaust controller 150 may control the deactivation of the equipment 210 according to the ascending order of the minimum values.

The method of controlling the exhausting of the equipment according to one or more embodiments may include predicting activation/deactivation of equipment included in a multi-equipment system in operation S100, determining an activation/deactivation order for the equipment in operation S200, and controlling exhausting of the equipment in operation S300. In addition, in the predicting of the activation/deactivation of the equipment in operation S100, while each of the equipment is activated/deactivated, activation differential pressures/deactivation differential pressures may be measured and maximum values/minimum values may be determined. In the determining of the activation/deactivation order for the equipment in operation S200, the maximum values may be arranged in descending order and the minimum values may be arranged in ascending order. In the controlling of the exhausting of the equipment in operation S300, by controlling the activation/deactivation of the equipment according to the arranging in order, a pressure change in the central pipe 230 may be optimized, thereby maximizing exhaust performance of the equipment 210.

In addition, the method of controlling the exhausting of the equipment according to one or more embodiments may include determining the activation/deactivation order for the equipment based on a simulation, and thus, exhaust performance of the equipment 210 may be significantly improved and stabilized, compared to a method of arbitrarily determining an activation/deactivation order for equipment based on empirical determination. In addition, in one or more embodiments, it is sufficient to have only the pressure sensor 240 arranged within the inlet 260 of the central pipe 230, and thus there is no need to place additional pressure sensors in the equipment 210 and the pipes 220.

For reference, pressure in pipes 220 varies for each of the equipment 210, and the impact on the central pipe 230 may also differ. When a pressure sensor is arranged in each of the pipes 220, an order may be determined based on this. However, in practical implementations, a pressure sensor is not arranged in each of the pipes 220, and thus it is not possible to monitor pressure changes in the pipes 220 of the respective equipment 210. However, installing sensors in all pipes 220 and monitoring them may incur astronomical costs. In addition, in a situation where pressure in the central pipe 230 is not sufficient, when the equipment 210 that generates a large pressure change is activated/deactivated, the pressure in the central pipe 230 may react more sensitively, thereby resulting in negative impacts, such as other equipment 210 malfunctioning or deactivating at the same time.

However, the method of controlling the exhausting of the equipment according to one or more embodiments may be based on a simulation, thereby reducing or preventing an increase in costs caused by arrangement of additional pressure sensors. In addition, the activation/deactivation order for the equipment 210 may be determined through a simulation by using a pressure change in the central pipe 230, and by controlling the activation/deactivation of the equipment 210. Accordingly, the pressure change in the central pipe 230 may be optimized, thereby maximizing exhaust performance of the equipment 210. As a result, the method of controlling the exhausting of the equipment according to one or more embodiments may contribute to a stable pressure change in the central pipe 230 and resultant stable operation of the equipment 210, in relation to exhausting of the multi-equipment system 200.

FIG. 4 is a flowchart illustrating an operation of predicting activation/deactivation of equipment according to one or more embodiments. Description of aspects that are the same as or similar to those described above may be omitted.

Referring to FIG. 4, in the method of controlling the exhausting of the equipment according to one or more embodiments, the predicting of the activation/deactivation of the equipment 210 in operation S100 may include receiving an input of information about equipment/pipes in operation S110. The information about the equipment/pipes may include information about the equipment 210 and information about the pipes 220. The information about the equipment 210 may include, for example, the type of exhaust gas used in each of the equipment 210 and the maximum exhaust amount of each of the equipment 210. In addition, the information about the pipes 220 may include, for example, the shape or exhaust capacity of each of the pipes 220.

After receiving the input of the information about the equipment/pipes, the simulation may be divided into a first simulation of the activation of the equipment 210 and a second simulation of the deactivation of the equipment 210 in operation S120. After dividing the simulation into the first simulation and the second simulation, the first simulation may be performed in operation S130 and the second simulation may be performed in operation S140. As shown in FIG. 4, the first simulation and the second simulation may be performed in parallel. In other words, the first simulation and the second simulation may be independently performed and may not affect each other.

An activation differential pressure, which is a difference between a first pressure measured when activating each of at least some of the equipment 210 and a second pressure before activating each of the at least some of the equipment 210, may be determined in the first simulation. The first pressure of the first simulation may correspond to activation pressure in FIG. 5A, and the second pressure of the first simulation may correspond to an n^{th} reference deactivation pressure in FIG. 5A. An activation differential pressure for each of at least some of the equipment 210 may be determined in the first simulation. Therefore, a plurality of activation differential pressures corresponding to the at least some of the equipment 210 may be determined in the first simulation.

A deactivation differential pressure, which is a difference between a first pressure measured when deactivating each of at least some of the equipment 210 and a second pressure before deactivating each of the at least some of the equipment 210, may be determined in the second simulation. The first pressure of the second simulation may correspond to deactivation pressure in FIG. 5B, and the second pressure of the second simulation may correspond to n^{th} reference activation pressure in FIG. 5B. A deactivation differential pressure for each of at least some of the equipment 210 may be determined in the second simulation. Therefore, a plurality of deactivation differential pressures corresponding to the at least some of the equipment 210 may be determined in the second simulation.

The performing of the first simulation in operation S130 is described in more detail in the description of FIG. 5A, and the performing of the second simulation in operation S140 is described in more detail in the description of FIG. 5B.

After performing the first simulation in operation S130 and/or performing the second simulation in operation S140, a result of the first simulation and/or the second simulation may be stored in the DB 130 in operation S150. In detail, maximum values determined in the first simulation may be stored in the DB 130. In addition, minimum values determined in the second simulation may be stored in the DB 130. In addition, before storing the result of the first simulation and/or the second simulation in the DB 130 in operation S150, all information necessary for the method of controlling the exhausting of the equipment may be pre-stored in the DB 130. For example, the information about the equipment 210 and the pipes 220 may be pre-stored in the DB 130 and then may be input into or transmitted to the equipment/pipe information input unit 110 and/or the simulation performance unit 120.

FIGS. 5A and 5B are flowcharts illustrating operations of performing a first simulation and an operation of performing a second simulation, according to one or more embodiments. Description of aspects that are the same as or similar to those described above may be omitted.

Referring to FIG. 5A, in the performing of the first simulation of operation S130 may include initializing n to N in operation S131. N may be a variable indicating the number of equipment 210 included in the multi-equipment system 200 and may be an integer of 2 or more. In addition, n may be a variable corresponding to the number of repetitions and may be an integer from 1 to N. For example, when the number of equipment 210 included in the multi-equipment system 200 is 9, N may be 9. In addition, as will be seen later, n ranges from 9 to 1, and thus a process of identifying a maximum value may be repeated nine times.

After n is initialized to N, an n^{th} reference deactivation pressure with all n equipment 210 being deactivated may be measured in operation S132. For example, when N is 9, n is 9, and thus while all nine equipment 210 are deactivated, a ninth reference deactivation pressure is measured. The ninth reference deactivation pressure may be measured through the pressure sensor 240 within the inlet 260 of the central pipe 230.

After measuring the n^{th} reference deactivation pressure, activation pressures may be measured while activating each of the n equipment 210 in operation S133. The activation pressures may include first to n^{th} activation pressures corresponding to the number of equipment 210. In detail, for example, when N is 9, first equipment may be activated, and a first activation pressure may be measured while the others are deactivated. The first activation pressure may be measured through the pressure sensor 240 within the inlet 260 of the central pipe 230. Next, second equipment may be activated, and a second activation pressure may be measured while the others are deactivated. The second activation pressure may also be measured through the pressure sensor 240 within the inlet 260 of the central pipe 230. In this manner, nine activation pressures corresponding to activation of nine equipment 210 may be measured.

After measuring the activation pressures, activation differential pressures, which are differences between the n^{th} reference deactivation pressure and the activation pressures, may be determined in operation S134. The activation differential pressures may include first to n^{th} activation differential pressures corresponding to the equipment 210. In detail, for example, when N is 9, a first activation differential pressure, which is a difference between the ninth reference deactivation pressure and the first activation pressure, may be determined. In addition, a second activation differential pressure, which is a difference between the ninth reference deactivation pressure and the second activation pressure, may be determined. In this manner, nine activation differential pressures corresponding to activation of nine equipment 210 may be determined.

After determining the activation differential pressures, a maximum value among the activation differential pressures may be identified in operation S135. For example, when N is 9, a highest value among the nine activation differential pressures is identified.

After identifying the maximum value, whether n is 2 or more may be determined in operation S136. When n is 2 or more (Yes), n is reduced by 1 in operation S137 and the measuring of the n^{th} reference deactivation pressure in operation S132 proceeds, and a subsequent process is repeated. In detail, for example, when N is 9, in the reducing of n by 1 in operation S137, n is reduced to 8, and in the measuring of the n^{th} reference deactivation pressure in operation S132, an eighth reference deactivation pressure may be measured. In addition, in the measuring of the n^{th} reference deactivation pressure (S132), while equipment 210 corresponding to the maximum value is maintained in an activation state and the remaining equipment 210 is deactivated, the n^{th} reference deactivation pressure, that is, the eighth reference deactivation pressure, may be measured. The eighth reference deactivation pressure may be also measured through the pressure sensor 240 within the inlet 260 of the central pipe 230.

For reference, the eighth reference deactivation pressure may be substantially the same as an activation pressure measured while the equipment corresponding to the maximum value is activated and the others are deactivated in the measuring of the activation pressures in operation S133 when n is 9. Therefore, after n becomes 8, in the measuring of the n^{th} reference deactivation pressure in operation S132, without an additional pressure measurement process, when n is 9, the activation pressure in the equipment corresponding to the maximum value may be used as the eighth reference deactivation pressure. The same may apply to subsequent other value of n.

Next, in the measuring of the activation pressures in operation S133, activation pressures may be measured while activating each of eight equipment. In other words, excluding the equipment (the activation state is maintained) corresponding to the maximum value, eight activation pressures may be measured in correspondence to the activation of the remaining eight equipment. In addition, in the determining of the activation differential pressures in operation S134, activation differential pressures, which are differences between the eighth reference deactivation pressure and the activation pressures, may be determined. Eight activation differential pressures may be determined in correspondence to the eight activation pressures. Next, in the identifying of the maximum value in operation S135, a maximum value among the eight activation differential pressures is identified.

Afterwards, after going through the determining of whether n is 2 or more in operation S136, this process may be repeated until n becomes 1. When a process of identifying one maximum value is referred to as one cycle, there may be nine cycles as n changes from 9 to 1. Therefore, nine maximum values may be identified. In addition, as the cycle progresses, n decreases, the n^{th} reference deactivation pressure may be measured while n equipment is deactivated and the others are activated, and n activation pressures may also be measured in correspondence to the n equipment.

In addition, because a reference deactivation pressure is fixed in each cycle, a maximum value of activation differential pressures from each cycle may correspond to a minimum value among activation pressures from each cycle. In addition, while the number of activated equipment 210 increases one by one for each cycle, activation pressures are measured, and thus as the cycle is repeated, a minimum value among activation pressures may gradually decrease. In other words, a minimum value among activation pressures from a first cycle may be the largest, and a minimum value among activation pressures from a last cycle may be the smallest.

When n is not 2 or more (No), that is, when n is 1, the first simulation may be terminated, and the storing of the result of the first simulation in the DB 130 in operation S150 proceeds. Operation S136 may have the option of (No) based on n being less than 3 or other values in accordance with the configuration of the equipment system.

Referring to FIG. 5B, the performing of the second simulation in operation S140 may include initializing n to N in operation S141 (N and n may correspond to these values described in relation to FIG. 5A). For example, when the number of equipment 210 included in the multi-equipment system 200 is 9, N may be 9. In addition, n ranges from 9 to 1, and thus a process of identifying a minimum value may be repeated nine times.

After n is initialized to N, an n^{th} reference activation pressure with all n equipment 210 being activated may be measured in operation S142. For example, when N is 9, n is 9, and thus while all nine equipment 210 are activated, a ninth reference activation pressure is measured. The ninth reference activation pressure may be measured through the pressure sensor 240 within the inlet 260 of the central pipe 230.

After measuring the n^{th} reference activation pressure, deactivation pressures may be measured while deactivating each of the n equipment 210 in operation S143. The deactivation pressures may include first to n^{th} deactivation pressures corresponding to the equipment 210. In detail, for example, when N is 9, first equipment 210 is deactivated, and a first deactivation pressure is measured while the others are activated. The first deactivation pressure may be measured through the pressure sensor 240 within the inlet 260 of the central pipe 230. Next, second equipment 210 is deactivated, and a second deactivation pressure is measured while the others are activated. The second deactivation pressure may also be measured through the pressure sensor 240 within the inlet 260 of the central pipe 230. In this manner, nine deactivation pressures corresponding to deactivation of nine equipment 210 may be measured.

After measuring the deactivation pressures, deactivation differential pressures, which are differences between the n^{th} reference activation pressure and the deactivation pressures, may be determined in operation S144. The deactivation differential pressures may include first to n^{th} deactivation differential pressures in correspondence to the equipment 210. In detail, for example, when N is 9, a first deactivation differential pressure, which is a difference between the ninth reference activation pressure and the first deactivation pressure, may be determined. In addition, a second deactivation differential pressure, which is a difference between the ninth reference activation pressure and the second deactivation pressure, may be determined. In this manner, nine deactivation differential pressures corresponding to deactivation of nine equipment 210 may be determined.

After determining the deactivation differential pressures, a minimum value among the deactivation differential pressures may be identified in operation S145. For example, when N is 9, a lowest value among the nine deactivation differential pressures is identified.

After identifying the minimum value, whether n is 2 or more may be determined in operation S146. When n is 2 or more (Yes), n may be reduced by 1 in operation S147, the measuring of the n^{th} reference activation pressure in operation S142 proceeds, and a subsequent process is repeated. In detail, for example, when N is 9, in the reducing of n by 1 in operation S147, n is reduced to 8, and in the measuring of the n^{th} reference activation pressure in operation S142, an eighth reference activation pressure may be measured. In addition, in the measuring of the n^{th} reference activation pressure (S142), while equipment 210 corresponding to the minimum value is maintained in a deactivation state and the remaining equipment 210 is activated, the n^{th} reference activation pressure, that is, the eighth reference activation pressure, may be measured. The eighth reference activation pressure may be also measured through the pressure sensor 240 within the inlet 260 of the central pipe 230.

For reference, the eighth reference activation pressure may be substantially the same as a deactivation pressure measured while the equipment 210 corresponding to the minimum value is deactivated and the others are activated in the measuring of the deactivation pressures in operation S143 when n is 9. Therefore, after n becomes 8, in the measuring of the n^{th} reference activation pressure in operation S142, without an additional pressure measurement process, when the n is 9, the deactivation pressure in the equipment 210 corresponding to the minimum value may be used as the eighth reference activation pressure. The same may apply to subsequent other n.

Next, in the measuring of the deactivation pressures in operation S143, deactivation pressures are measured while deactivating each of eight equipment 210. In other words, excluding the equipment 210 (the deactivation state is maintained) corresponding to the minimum value, eight deactivation pressures may be measured corresponding to the deactivation of the eight equipment 210. In addition, in the determining of the deactivation differential pressures in operation S144, deactivation differential pressures, which are differences between the eighth reference activation pressure and the deactivation pressures, may be determined. Eight deactivation differential pressures may be determined in correspondence to the eight deactivation pressures. Next, in the identifying of the minimum value in operation S145, a minimum value among the eight deactivation differential pressures is identified.

Afterwards, after the determining of whether n is 2 or more in operation S146, this process may be repeated until n becomes 1. When a process of identifying one minimum value is referred to as one cycle, there may be nine cycles as n changes from 9 to 1. Therefore, nine minimum values may be identified. In addition, as the cycle progresses, n decreases, the n^{th} reference activation pressure may be measured while n equipment is activated and the others are deactivated, and n deactivation pressures may also be measured in correspondence to the n equipment.

In addition, because a reference activation pressure is fixed in each cycle, a minimum value of deactivation differential pressures from each cycle may correspond to a maximum value among deactivation pressures from each cycle. In addition, while the number of deactivated equipment 210 increases one by one for each cycle, deactivation pressures are measured, and thus as the cycle is repeated, a maximum value among deactivation pressures may gradually increase. In other words, a maximum value among deactivation pressures from a first cycle may be the smallest, and a maximum value among deactivation pressures from a last cycle may be the largest.

When n is not greater than 2 or equal to 2 (No), that is, when n is 1, the second simulation may be terminated, and the storing of the result of the second simulation in the DB 130 in operation S150 may be performed.

FIG. 6 is a flowchart illustrating an operation of determining an activation/deactivation order for equipment according to one or more embodiments. Description of aspects that are the same as or similar to those described above may be omitted.

Referring to FIG. 6, in the method of controlling the exhausting of the equipment according to one or more embodiments, the determining of the activation/deactivation order for the equipment 210 may include dividing this operation into determining the activation order for the equipment 210 and determining the deactivation order for the equipment 210 in operation S210. As shown in FIG. 6, the determining of the activation order for the equipment 210 and the determining of the deactivation order for the equipment 210 may be performed in parallel. In other words, the determining of the activation order for the equipment 210 and the determining of the deactivation order for the equipment 210 are independent and may not affect each other.

In detail, in the case of the determining of the activation order for the equipment 210, maximum values may be arranged in descending order in operation S220. In this regard, each of the maximum values may correspond to a maximum value among activation differential pressures from each cycle in the first simulation. In addition, because a reference deactivation pressure is fixed in each cycle, each of the maximum values may correspond to a minimum value among activation pressures from each cycle.

The arranging of the maximum values in descending order may indicate that equipment corresponding to a maximum value among activation differential pressures from a first cycle, equipment corresponding to a maximum value among activation differential pressures from a second cycle, and the like are arranged in order. In addition, the arranging of the maximum values in descending order may also indicate that equipment corresponding to a minimum value among activation pressures from a first cycle, equipment corresponding to a minimum value among activation pressures from a second cycle, and the like are arranged in order.

In addition, in the case of the determining of the deactivation order for the equipment 210, minimum values may be arranged in ascending order in operation S230. In this regard, each of the minimum values may correspond to a minimum value among deactivation differential pressures from each cycle in the second simulation. In addition, because a reference activation pressure is fixed in each cycle, each of the minimum values may correspond to a maximum value among deactivation pressures from each cycle.

In addition, the arranging of the minimum values in ascending order may indicate that equipment corresponding to a minimum value among deactivation differential pressures from a first cycle, equipment corresponding to a minimum value among deactivation differential pressures from a second cycle, and the like are arranged in order. In addition, the arranging of the minimum values in ascending order may also indicate that equipment corresponding to a maximum value among deactivation pressures from a first cycle, equipment corresponding to a maximum value among deactivation pressures from a second cycle, and the like are arranged in order.

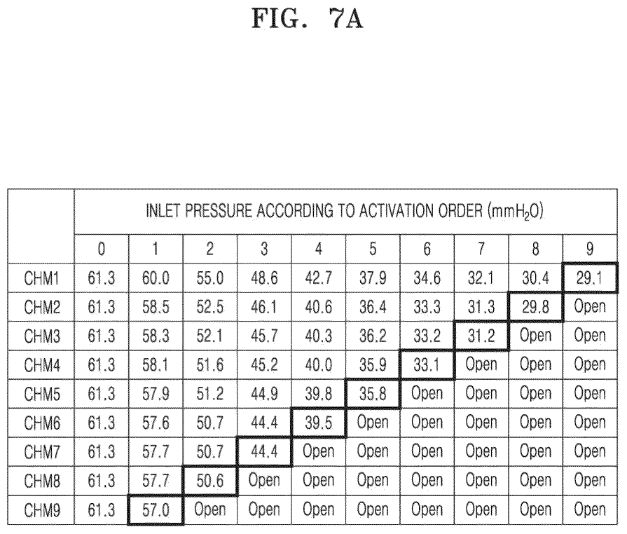

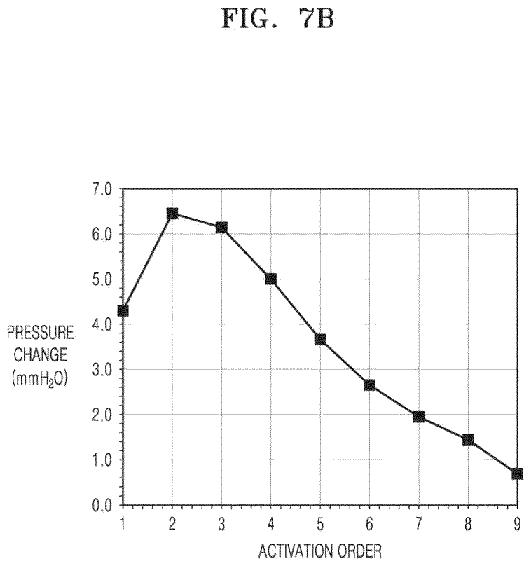

FIG. 7A is an activation table illustrating a result of a first simulation according to an activation order according to one or more embodiments. FIG. 7B is a graph illustrating a pressure change according to an activation order for equipment based on maximum values according to one or more embodiments. In FIG. 7A, CHM1 to CHM9 in the vertical direction are the names of equipment, and 0 to 9 in the horizontal direction may correspond to cycles for identifying maximum values. In FIG. 7B, the x axis may represent an activation order, and the y axis may represent a pressure change according to activation of corresponding equipment. Description of aspects that are the same as or similar to those described above may be omitted.

Referring to FIG. 7A, in a zeroth cycle, nine equipment are all deactivated, and at this time, a ninth reference deactivation pressure may be measured. For example, the ninth reference deactivation pressure may be 61.3. In the first cycle, activation pressures may be measured while activating each of the equipment. For example, an activation pressure in the first equipment CHM1 may be 60.0, and an activation pressure in the ninth equipment CHM9 may be 57.0. When an activation differential pressure is determined, in the case of activation of the first equipment CHM1, a first activation differential pressure may be 1.3, and in the case of activation of the ninth equipment CHM9, a ninth activation differential pressure may be 4.3. When compared to other activation differential pressures, 4.3 of the ninth activation differential pressure may be a maximum value. Therefore, the ninth activation differential pressure may be identified as the maximum value.

In a second cycle, while the ninth equipment CHM9 is maintained in an activation state, the same process may proceed. In other words, while the ninth equipment CHM9 is maintained in the activation state and the others are in a deactivation state, an eighth reference deactivation pressure may be measured. The eighth reference deactivation pressure may be substantially the same as the ninth activation pressure from the first cycle, and accordingly, the eighth reference deactivation pressure may be 57.0. Next, activation pressures may be measured while activating each of the equipment 210. For example, an activation pressure in the first equipment CHM1 may be 55.0, and an activation pressure in the eighth equipment CHM8 may be 50.6. When an activation differential pressure is determined, in the case of activation of the first equipment CHM1, a first activation differential pressure may be 57.0−55.0=2, and in the case of activation of the eighth equipment CHM8, an eighth activation differential pressure may be 57.0−50.6=6.4. When compared to other activation differential pressures, 6.4 of the eighth activation differential pressure may be a maximum value. Therefore, the eighth activation differential pressure may be identified as the maximum value.

By repeating this process, maximum values from the first cycle to the ninth cycle may be identified. In the table of FIG. 7A, activation pressures in the equipment corresponding to the maximum values are indicated in bold rectangles. As described above, because a reference deactivation pressure is fixed in each cycle, a maximum value among activation differential pressures from each cycle may correspond to a minimum value among activation pressures from each cycle. In addition, in the case of a third cycle, the sixth equipment CHM6 and the seventh equipment CHM7 have the same activation pressure and thus have the same activation differential pressure, and thus two maximum values may be determined. Therefore, in this case, one of the two may be chosen arbitrarily. For example, in the case of the table of FIG. 7A, the seventh equipment CHM7 is selected as equipment corresponding to a maximum value.

Referring to FIG. 7B, the graph of FIG. 7B shows a pressure change when the equipment is activated according to a descending order of the maximum values based on the table of FIG. 7A. For example, based on the table of FIG. 7A, the equipment 210 may be activated sequentially from the ninth equipment CHM9 to the first equipment CHM1. Accordingly, when the ninth equipment CHM9 is activated, a pressure change of 61.3−57.0=4.3 may occur, and when the eighth equipment CHM8 is activated while the ninth equipment CHM9 is activated, a pressure change of 57.0−50.6=6.4 may occur. In FIG. 7A, the activation order is determined sequentially from the ninth equipment CHM9 to the first equipment CHM1, when the sixth equipment CHM6 is selected as equipment corresponding to a maximum value in the third cycle, the activation order for the equipment 210 may be changed to the ninth equipment CHM9, the eighth equipment CHM8, the sixth equipment CHM6, the seventh equipment CHM7, the fifth equipment CHM5, and the like.

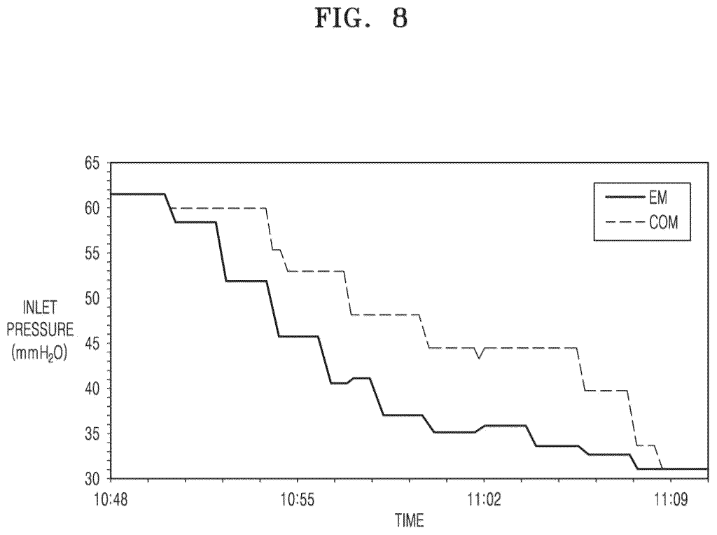

FIG. 8 is a graph showing a comparison of changes in pressure in a central pipe according to methods of controlling exhausting of equipment of a comparative example and one or more embodiments, where the solid line represents the method of controlling the exhausting of the equipment according to one or more embodiments (EM), and the dashed line represents a method of controlling exhausting of equipment of the comparative example (COM). In the graph of FIG. 8, the x axis represents time, and the y axis represents a pressure change of the central pipe according to time. Descriptions are provided with reference to FIGS. 1 to 7B, and those already provided in the descriptions of FIGS. 1 to 7B are briefly provided or omitted.

Referring to FIG. 8, in the case of the method of controlling the exhausting of the equipment according to one or more embodiments (EM), the equipment may be activated according to the descending order of the maximum values, as described with reference to FIGS. 6 to 7B. As can be seen through the graph, it may be seen that pressure in the inlet of the central pipe 230 sequentially decreases. Due to such sequential pressure reduction, exhausting may be smoothly achieved. In contrast, in the case of the method of controlling the exhausting of the equipment of the comparative example (COM), it may be seen that in the latter part, pressure does not decrease, but then suddenly decreases. As such, such sudden pressure change may cause damage to the equipment and the pipes and may affect processes of other equipment. As a result, the method of controlling the exhausting of the equipment according to one or more embodiments (EM) may maximize exhaust performance by optimizing an activation order for the equipment in the multi-equipment system.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A method of controlling exhausting of equipment in a multi-equipment system, the method comprising:
receiving an input of information about a plurality of equipment and a plurality of pipes corresponding to the plurality of equipment, wherein the plurality of pipes are connected to a central pipe;
performing a simulation of activation or deactivation of the plurality of equipment based on the information and a pressure of the central pipe; and
determining an activation order or a deactivation order for the plurality of equipment based on a result of the simulation.

2. The method of claim 1, wherein the central pipe comprises an outlet through which exhaust gas is discharged, an inlet opposite to the outlet, and a pressure sensor within the inlet and configured to measure the pressure of the central pipe, and
wherein the performing the simulation comprises determining a difference between a first pressure in the central pipe when activating or deactivating each of at least some of the plurality of equipment and a second pressure in the central pipe before activating or deactivating each of the at least some of the plurality of equipment.

3. The method of claim 1, wherein the performing the simulation comprises:
dividing the simulation into a first simulation simulating activation of the plurality of equipment and a second simulation simulating deactivation of the plurality of equipment; and
performing the first simulation in parallel with the second simulation.

4. The method of claim 3, wherein the plurality of equipment comprises N equipment, and N is an integer of 2 or more,
wherein the performing the first simulation comprises:
initializing n to N, wherein n is an integer from 1 to N
(a) measuring an n^{th} reference deactivation pressure while n equipment of the N equipment is deactivated;
(b) measuring activation pressures while activating each of the n equipment of the N equipment;
(c) determining activation differential pressures that are differences between the n^{th} reference deactivation pressure and the corresponding activation pressures;
(d) identifying a maximum value among the activation differential pressures;
(e) determining whether n is 2 or more,
based on n being 2 or more, reducing n by 1 and repeating operations (a)-(e), and
based on n is less than 2, terminating the first simulation, and
wherein, the measuring the n^{th} reference deactivation pressure after n is reduced by 1 comprises maintaining equipment of the N equipment corresponding to the maximum value in an activation state and maintaining the remaining equipment of the N equipment in a deactivation state.

5. The method of claim 4, wherein the measuring the activation pressures comprises measuring an activation pressure in an m^{th} equipment among the n equipment while the m^{th} equipment is activated and the remaining equipment except the m^{th} equipment are maintained in a deactivation state, and
wherein m is an integer from 1 to n.

6. The method of claim 4, wherein the n^{th} reference deactivation pressure is substantially the same as an activation pressure of the plurality of equipment corresponding to the maximum value.

7. The method of claim 3, wherein the plurality of equipment comprises N equipment, and N is an integer of 2 or more,
wherein the performing the second simulation comprises:
initializing n to N, wherein n is an integer from 1 to N;
(a) measuring an n^{th} reference activation pressure while n equipment of the N equipment is activated;
(b) measuring deactivation pressures while deactivating each of the n equipment of the N equipment;
(c) determining deactivation differential pressures that are differences between the n^{th} reference activation pressure and the corresponding deactivation pressures;
(d) identifying a minimum value among the deactivation differential pressures;
(e) determining whether n is 2 or more,
based on n being 2 or more, reducing n by 1 and the repeating operations (a)-(e), and
based on n being less than 2, terminating the second simulation, and
wherein, the measuring the n^{th} reference activation pressure after n is reduced by 1 comprises maintaining equipment of the N equipment corresponding to the minimum value in a deactivation state and maintaining the remaining equipment of the N equipment in an activation state.

8. The method of claim 7, wherein the measuring the deactivation pressures comprises measuring a deactivation pressure in an m^{th} equipment among the n equipment while the m^{th} equipment is deactivated and the remaining equipment except the m^{th} equipment are maintained in an activation state, and
wherein m is an integer from 1 to n.

9. The method of claim 3, further comprising, after the performing the simulation, storing a result of the first simulation and a result of the second simulation in a database,
wherein the determining the activation order or the deactivation order comprises arranging maximum values of the result of the first simulation in descending order, and arranging minimum values of the result of the second simulation in ascending order.

10. The method of claim 9, further comprising, after the determining of the activation order or the deactivation order, controlling exhausting of the plurality of equipment,
wherein the controlling the exhausting of the plurality of equipment comprises activating the exhausting of the plurality of equipment according to the descending order of the maximum values, or deactivating the exhausting of the plurality of equipment according to the ascending order of the minimum values.

11. The method of claim 10, wherein the controlling the exhausting of the plurality of equipment further comprises controlling activation or deactivation of both a process chamber and a pipe in each of the plurality of equipment, or controlling activation or deactivation of a pipe after activation or deactivation of the process chamber.

12. The method of claim 1, further comprising measuring, by aa pressure sensor in the central pipe, the pressure of the central pipe.

13. A method of controlling exhausting of equipment in a multi-equipment system, the method comprising:
receiving an input of information about a plurality of equipment and about a plurality of pipes corresponding to the plurality of equipment, wherein the plurality of pipes are connected to a central pipe;
performing a simulation of activation or deactivation of the plurality of equipment based on the information and based on a pressure of the central pipe;
storing a result of the simulation in a database;
determining an activation order or a deactivation order for the plurality of equipment based on data stored in the database; and
controlling exhausting of the plurality of equipment based on the activation order or the deactivation order.

14. The method of claim 13, wherein the performing the simulation comprises determining a difference between a first pressure in the central pipe when activating or deactivating each of at least some of the plurality of equipment and a second pressure in the central pipe before activating or deactivating each of the at least some of the plurality of equipment.

15. The method of claim 13, wherein the performing the simulation comprises:
dividing the simulation into a first simulation simulating activation of the plurality of equipment and a second simulation simulating deactivation of the plurality of equipment;
performing the first simulation; and
performing the second simulation in parallel with the first simulation.

16. The method of claim 15, wherein the plurality of equipment comprises N equipment, wherein N is an integer of 2 or more,
wherein the performing the first simulation comprises:
initializing n to N, wherein n is an integer from 1 to N
(a) measuring an n^{th} reference deactivation pressure while n equipment of the N equipment is deactivated;
(b) measuring activation pressures while activating each of the n equipment of the N equipment;
(c) determining activation differential pressures that are differences between the n^{th} reference deactivation pressure and the corresponding activation pressures;
(d) identifying a maximum value among the activation differential pressures;
(e) determining whether n is 2 or more,
based on n being 2 or more, reducing n by 1 and repeating operations (a)-(e), and
based on n is less than 2, terminating the first simulation, and
wherein, the measuring the n^{th} reference deactivation pressure after n is reduced by 1 comprises maintaining equipment of the N equipment corresponding to the maximum value in an activation state and maintaining the remaining equipment of the N equipment in a deactivation state.

17. The method of claim 15, wherein the plurality of equipment comprises N equipment, wherein N is an integer of 2 or more,
wherein the performing of the second simulation comprises:
initializing n to N, wherein n is an integer from 1 to N;
(a) measuring an n^{th} reference activation pressure while n equipment of the N equipment is activated;
(b) measuring deactivation pressures while deactivating each of the n equipment of the N equipment;
(c) determining deactivation differential pressures that are differences between the n^{th} reference activation pressure and the corresponding deactivation pressures;
(d) identifying a minimum value among the deactivation differential pressures;
(e) determining whether n is 2 or more,
based on n being 2 or more, reducing n by 1 and the repeating operations (a)-(e), and
based on n being less than 2, terminating the second simulation, and
wherein, the measuring of the n^{th} reference activation pressure after n is reduced by 1 comprises maintaining equipment of the N equipment corresponding to the minimum value in a deactivation state and maintaining the remaining equipment of the N equipment in an activation state.

18. The method of claim 15, wherein the storing the result of the simulation in the database comprises storing a result of the first simulation and a result of the second simulation in the database,
wherein the determining the activation order or the deactivation order comprises arranging maximum values of the result of the first simulation in descending order, and arranging minimum values of the result of the second simulation in ascending order, and
wherein the controlling the exhausting of the plurality of equipment comprises activating the plurality of equipment according to the descending order of the maximum values, or deactivating the plurality of equipment according to the ascending order of the minimum values.

19. A method of controlling exhausting of a plurality of equipment in a multi-equipment system, the method comprising:
performing a simulation of activation order or deactivation of the plurality of equipment, wherein the plurality of equipment are connected to a plurality of pipes that are connected to a central pipe;
determining an activation order or a deactivation order for the plurality of equipment based on a result of the simulation; and
controlling exhausting of the plurality of equipment based on the activation order or the deactivation order,
wherein the simulation is performed based on a pressure in the central pipe.

20. The method of claim 19, wherein the performing the simulation comprises:
dividing the simulation into a first simulation simulating activation of the plurality of equipment and a second simulation simulating deactivation of the plurality of equipment;
performing the first simulation; and
performing the second simulation in parallel with the first simulation,
wherein the performing the first simulation comprises determining activation differential pressures corresponding differences between activation pressures when each of at least some of the plurality of equipment is activated and a reference deactivation pressure before each of the at least some of the plurality of equipment is activated, and
wherein the performing the second simulation comprises determining deactivation differential pressures corresponding differences between deactivation pressures when each of at least some of the plurality of equipment is deactivated and a reference activation pressure before each of the at least some of the plurality of equipment is deactivated.
